(19) United States
(12) Patent Application Publication
(10) Pub. No.: US 2026/0210464 A1
(43) Pub. Date: Jul. 23, 2026

(54) PIPE ISOLATION JOINTS FOR ELECTRICAL ISOLATION OF HEATING TUBES SEGMENTS IN ELECTRIC IMPEDANCE FURNACES

(71) Applicant: SABIC GLOBAL TECHNOLOGIES B.V., BERGEN OP ZOOM (NL)

(72) Inventors: Subramanian SANKARAN, Bangalore (IN); Michael Edward HUCKMAN, Bangalore (IN); Joseph William SCHROER, Bangalore (IN)

(73) Assignee: SABIC GLOBAL TECHNOLOGIES B.V., BERGEN OP ZOOM (NL)

(21) Appl. No.: 19/142,010

(22) PCT Filed: Dec. 11, 2023
(86) PCT No.: PCT/EP2023/085140

§ 371 Date: Jun. 20, 2025

(30) Foreign Application Priority Data
Dec. 29, 2022 (EP) 22217068.0

(51) Int. Cl. F16L 25/02

(52) U.S. Cl. CPC F16L 25/026

(57) ABSTRACT

This disclosure includes isolation joint connection assemblies for making an electrically insulated/isolated connection between two electrically conductive structures. Some such connection assemblies comprise: an electrically conductive first flange, an electrically conductive second flange, an insulating disc comprising an electrically non-conductive material that will remain solid and electrically nonconductive at temperatures up to at least 300° C. and voltages up to at least 200 Volts; a plurality of fastener insulators comprising an electrically non-conductive material, each fastener insulator defining one or more fastener holes; one or more insulating sleeves each comprising an electrically non-conductive material and defining an inner fastener channel; and one or more electrically conductive fastener assemblies with enlarged securing portions.

### FIELD OF DISCLOSURE

The present disclosure is generally related to industrial furnaces and, more particularly but not by way of limitation, to pipe isolation joints for electrically isolating tube segments, such as heating tubes in impedance furnaces.

### BACKGROUND

Chemical synthesis plants are utilized to provide a variety of chemicals. Often, a dedicated fuel is burned or combusted to provide heat of reaction for chemical synthesis, energy to heat one or more process streams, energy to vaporize liquids (e.g., boil water used as a diluent), energy to do work (e.g., drive a compressor or pump), or energy for other process operations throughout the chemical synthesis plant. Such burning or combustion of fuels results in the production of flue gases that contain CO₂, which can be harmful to the environment, and also results in a loss of energy efficiency of the process. Likewise, steam is often conventionally utilized as a plant-wide heat and/or energy transfer fluid within chemical synthesis plants. The steam utilized for the heat and/or energy transfer is often produced via the combustion of a fuel, resulting in the production of additional flue gas and further energy efficiency losses during the chemical synthesis.

Certain components could theoretically be powered by electricity. However, the electrification of certain components in chemical synthesis plants presents additional issues and challenges. For example, in steam cracking processes, electrically heated pyrolysis furnaces, and electrically heated reactor furnaces in steam methane reforming (SMR) processes, may present issues or may be subject to considerations that are different than and/or not necessarily present in combustion-driven pyrolysis furnaces. As one example, impedance furnaces typically utilize electric current flowing through the walls of tubes to heat fluids flowing through the tubes, such that the tube becomes both the conduit for the process and the conducting element for electric heating.

However, such impedance furnaces can be economically challenging because the tubes, which are energized electrically, are connected to upstream and downstream piping and/or manifold systems that are not energized. The conventional approach to energizing the tubes in such an electric furnace is to configure the circuit such that the high voltage or potential is at the middle of each tube, and the low voltage or potential (e.g., very close to ground) is at each ends of the tube (near the upstream/downstream connections). In this configuration, energization of the upstream/downstream piping is avoided by causing current to flow into and out of the furnace tubing within the furnace itself. But this arrangement makes each furnace tube its own circuit and, using conventional tube materials of construction (usually various hi alloy metals) the voltage drop across the circuit is very low-typically from 10 Volts (V) to 50 V.

### SUMMARY

With a small voltage drop of 10 V to 50 V, delivering the heating duty of large industrial furnaces-for example, from 10 megawatts (MW) to 250 MW (e.g., 100 MW)-requires enormous current. For example, a 20 MW furnace at 20V would require 1.0 million amps, for which the electrical equipment-such as step down transformers, switch gear, thyristors, hook up panels, copper conductor, and associated components-can be prohibitively expensive. Moreover, the complexity of the electrical equipment required for such massive current introduces heat losses that can make a low-voltage impedance furnace relatively inefficient. As such, higher voltages would be helpful to make impedance furnaces commercially viable.

One way to achieve higher voltage is to electrically insulate the furnace tubes from their upstream/downstream piping connections. With the heater tubes electrically isolated, an electrical circuit can be configured with the furnace tubes connected in series, such that the voltage drop can be much larger, for example, 480 V, 4160 V, or 13,200 V (13.2 kV), which are standard voltages already used (and therefore available) at industrial sites. At these higher voltages, the required current is proportionally less, as are the costs and complexity of the required electrical equipment. For example, a 20 MW furnace at 4160 V requires only 4800 amps (versus 1.0 million amps at 20 V), such that the complexity and cost of required electrical equipment can be significantly reduced relative to that required for much-larger currents and lower voltages. Heat losses are also reduced, such that the high voltage furnace can be significantly more efficient.

Electrical insulation can be achieved with isolation joints that each mechanically couple two electrically conductive structures while preventing electrical communication between the structures, at least under certain conditions (e.g., below a breakdown voltage at a given temperature). For example, such isolation joints can provide an electrically insulating/isolated connection between two pipe flanges, a pipe flange and a piece of equipment such as a transfer line exchanger (TLE), a header, a manifold, a mixer, or other fitting. In the pipe-pipe example, a pipe isolation joint (PIJ) can couple an electrically conductive furnace tube to an electrically conductive upstream or downstream pipe or manifold, with a sealed connection between their respective flowpaths of the tube and pipe/manifold, and without allowing electrical connection or current flow between the tubes and the pipe/manifold. For example, dielectric or other electrically insulating material can be disposed between the tube and the pipe/manifold to prevent physical contact between their respective materials. Different dielectric or other electrically insulating materials can be selected for different applications. For example, with increasing temperature, at least some dielectrics will undergo changes in the dielectric properties that may being to allow current to pass, for example at higher voltages. Stated another way, with increasing temperature, the ability of a dielectric to withstand a voltage difference without current flow diminishes and eventually breaks down. In addition to appropriate selection of dielectric materials for the PIJ, other characteristics may also be selected to ensure desired electrically insulating properties; for example, increasing the thickness of the dielectric material can increase the breakdown voltage at which the dielectric will begin to allow current to flow (and can therefore increase the temperature at which the breakdown voltage falls below a desired threshold).

In some instances, such a PIJ may also include additional gasket or seal material between the dielectric material and the material of the tube or pipe/manifold to provide or supplement a sealed connection. Such gasket or seal material need not be electrically insulating as long as the dielectric material is configured to provide electrical insulation between the electrically conductive materials of the heater tube and the pipe/manifold, and between those materials and that of any fasteners extending therebetween. Stated another way, the gasket or seal material may be electrically conductive as long as that gasket or seal material does not complete a circuit between the heater tube and the pipe/manifold from which the heater tube is separated by the PIJ.

The present disclosure includes pipe isolation joints, such as may be used in industrial-scale impedance furnaces (e.g., for steam cracking, steam methane reforming, and/or various other applications) to electrically isolate segments of furnace tubes and thereby enable the use of higher voltages and improved efficiency for such industrial scale impedance furnaces.

Some configurations of the present connection assemblies comprise: an electrically conductive first flange defining a first opening; an electrically conductive second flange defining a second opening; an insulating disc defining a disc opening, the insulating disc comprising an electrically non-conductive material that will remain solid and electrically nonconductive at temperatures up to at least 300° C. and voltages up to at least 200 Volts; a plurality of fastener insulators comprising an electrically non-conductive material, each fastener insulator defining one or more fastener holes; one or more insulating sleeves comprising an electrically non-conductive material, each defining an inner fastener channel and having an outer profile configured to extend through the first opening and the second opening, and into the disc opening; and one or more fastener assemblies each having a longitudinal medial portion, and first and second retention portions each having a transverse dimension larger than a corresponding transverse dimension of the medial portion. In some such configurations of the present connection assemblies, the first flange is configured to be coupled to the second flange with the insulating disc between the first and second flanges such that: (1) the insulating sleeve extends through the first opening and the second opening, and into the disc opening; (2) the fastener assembly extends through the insulating sleeve with one of the fastener insulators between the first retention portion and the first flange, and another one of the fastener insulators between the second retention portion and the second flange; (3) the electrically nonconductive material(s) of each of the insulating disc, insulating sleeve(s), and fastener insulator(s) will remain solid and electrically nonconductive at temperatures up to at least 300° C. and voltages up to at least 200 Volts; and/or (4) the insulating disc, insulating sleeve(s), and fastener insulators prevent the electrically conductive material of the fastener assembly from contacting either flange and prevent the flanges from contacting each other.

In some configurations of the present connection assemblies, the electrically nonconductive material(s) of each of the insulating disc, insulating sleeve(s), and fastener insulator(s) will remain solid and electrically nonconductive at temperatures up to at least 600° C. and voltages up to at least 500 Volts.

In some configurations of the present connection assemblies, each of the fastener insulators is unitary with a corresponding one of the insulating sleeve(s).

In some configurations of the present connection assemblies, each of the insulating sleeves comprises two sub-sleeves, a first sub-sleeve configured to extend through the first opening and into the disc opening, and a second sub-sleeve configured to extend through the second opening and into the disc opening.

In some configurations of the present connection assemblies, each of the insulating sleeves comprises a single sleeve configured to extend through the first opening, the disc opening, and the second opening.

In some configurations of the present connection assemblies, each of the fastener holes in the plurality of fastener insulators is sized to receive an end of one of the insulating sleeves, and where the first flange is configured to be coupled to the second flange with the insulating disc between the first and second flanges such that a first end of each insulating sleeve extends into the fastener hole of the one of the fastener insulators, and a second end of the insulating sleeve extends into the other of the fastener insulators.

In some configurations of the present connection assemblies, the plurality of fastener insulators comprises a plurality of washers.

In some configurations of the present connection assemblies, the first flange is coupled to a pipe, and the second flange is coupled to a support structure.

In some configurations of the present connection assemblies, the first flange defines a primary first passage and a plurality of the first openings spaced from one other around the first passage; the second flange defines a primary second passage and a plurality of the second openings spaced from one other around the second passage; the insulating disc defines a primary disc passage and a plurality of the disc openings spaced from one another around the disc passage; a plurality of the insulating sleeves; a plurality of the fastener assemblies. In some such configurations, the first flange is configured to be coupled to the second flange with the insulating disc between the first and second flanges such that: (1) the first, disc, and second primary passages are aligned; (2) each of the insulating sleeves extends through one of the first openings and one of the second openings, and into one of the disc openings; (3) each of the fastener assemblies extends through a corresponding one of the insulating sleeves with one of the fastener insulators between the first retention portion and the first flange, and another one of the fastener insulators between the second retention portion and the second flange; and/or (4) the insulating disc, insulating sleeves, and fastener insulators prevent the electrically conductive material of the fastener assemblies from contacting either flange and prevent the flanges from contacting each other. Some such configurations further comprise: two gaskets each defining a primary gasket passage and a plurality of gasket openings spaced from one other around the gasket passage; where the first flange is configured to be coupled to the second flange with the insulating disc between the first and second flanges, and the two gaskets disposed between the insulating disc and respective ones of the first and second flanges, such that: each of the insulating sleeves extends through one of the first openings and one of the second openings, through one of the gasket openings, and into one of the disc openings; and the gaskets are compressed to prevent fluid from leaking out of the first, disc, and second passages between the insulating disc and the flanges. In some such configurations, the first passage, disc passage, and second passage each have an inner diameter of from 1 inch to 10 inches.

In some configurations of the present connection assemblies, the electrically non-conductive material of each of the insulating disc, fastener insulators, and insulating sleeves comprises ceramic (e.g., high-purity alumina (>98%)).

In some configurations of the present connection assemblies, each fastener assembly comprises a bolt and a nut.

Some configurations of the present pipe joints comprise: a tube having a first end, a second end, and a central passage extending from the first end to the second end; a first flange coupled to the first end of the tube and defining a first passage in fluid communication with the central passage of the tube, the first flange defining a plurality of fastener first openings spaced from one another around the first passage; and a second flange coupled to the second end of the tube and defining a second passage in fluid communication with the central passage of the tube, the second flange defining a plurality of fastener second openings spaced from one another around the second passage; where the tube, first flange, and second flange comprising an electrically non-conductive material that will remain solid and electrically nonconductive at temperatures up to 300° C. and voltages up to at least 200 Volts. Some such configurations further comprise: electrically conductive reinforcing members coupled to and extending along at least a portion of the tube; where the reinforcing members to not extend to a mating face of either of the flanges.

The present assemblies can be configured such that adjacent portions of electrically conductive surfaces are separated by either a minimum thickness of a solid, electrically nonconductive material or by a minimum space or air gap. For example, the minimum thickness can be 0.15 inches or larger (e.g., larger than any one of or between any two of: 0.15 inches, 0.20 inches, 0.25 inches, 0.30 inches, 0.35 inches, 0.40 inches, 0.45 inches, 0.50 inches, or larger); and/or the minimum space or air gap can be 0.15 inches or larger (e.g., larger than any one of or between any two of: 0.15 inches, 0.20 inches, 0.25 inches, 0.30 inches, 0.35 inches, 0.40 inches, 0.45 inches, 0.50 inches, or larger).

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any embodiment of the present apparatuses, kits, and methods, the term “substantially” may be substituted with “within [a percentage] of” what is specified, where the percentage includes 0.1, 1, 5, and/or 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus or kit that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, an apparatus, device or system that is configured in a certain way is configured in at least that way, but it can also be configured in other ways than those specifically described.

Any embodiment of any of the present apparatuses and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

Some details associated with the aspects of the present disclosure are described above, and others are described below. Other implementations, advantages, and features of the present disclosure will become apparent after review of the entire application, including the Brief Description of the Drawings, Detailed Description, and the claims.

### BRIEF DESCRIPTION OF THE DRAWINGS

The following drawings illustrate by way of example and not limitation. For the sake of brevity and clarity, every feature of a given structure is not always labeled in every figure in which that structure appears. Identical labels or reference numbers do not necessarily indicate an identical structure. Rather, the same reference number may be used to indicate a similar feature or a feature with similar functionality, as may non-identical reference numbers. Dimensioned figures are drawn to scale (unless otherwise noted), meaning the sizes of the depicted elements are accurate relative to each other for at least the embodiment depicted in the figures.

FIG. 1 depicts block flow diagram of a generalized steam cracking plant or process.

FIG. 2 depicts a block flow diagram of the pyrolysis reaction section of the plant or process of FIG. 1.

FIG. 3 depicts a conceptual diagram of a first example of an impedance furnace for use in the pyrolysis reaction section of FIG. 2.

FIG. 4 depicts a cross-sectional side view of a first example of the present pipe isolation joints for use in impedance furnaces such as the example of FIG. 3.

FIG. 5 depicts a plan view of an insulating disc for use with the pipe isolation joint of FIG. 4.

FIGS. 6A, 6B, and 6B depict partially cutaway, cross-sectional views of different configurations of fastener insulators configured for use with the pipe isolation joint of FIG. 4.

FIG. 7 depicts a cross-sectional view of electrically isolating connection for a pipe or tubing hanger.

FIGS. 8A and 8B depict, respectively, a perspective view and a cross-sectional view of an electrically isolating pipe joint.

### DETAILED DESCRIPTION

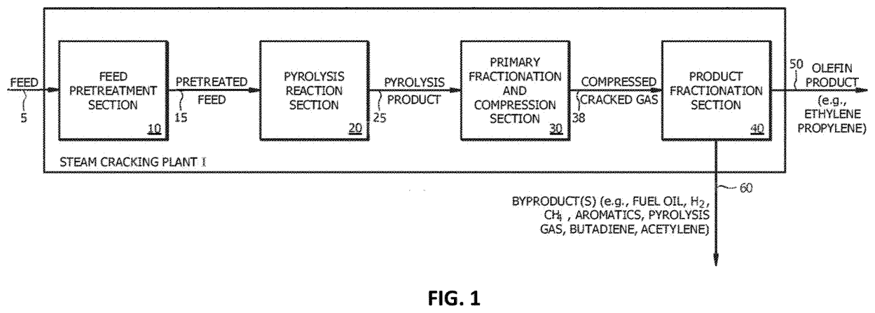

Referring now to the drawings, and more particularly to FIG. 1, shown there is a block flow diagram of an example of a generalized steam cracking plant or process, which includes one or more of the following process sections for converting a feed stream 5 into a desired olefin product stream 50: a feed pretreatment section 10, a pyrolysis reaction section 20, a primary fractionation and compression section 30, a product fractionation (separation) and compression section 40, or a combination thereof. Such sections will be described briefly in the next few paragraphs, and in more detail hereinbelow.

Feed pretreatment section 10 can be configured to adjust the pressure of a feed 5, possibly remove undesirable components (e.g., carbon dioxide (CO₂), mercury, sulfur (H₂S)) from a feed, combine an incoming feed with a stored feed to minimize variations in the feed to the pyrolysis reaction section 20, and/or preheat the feed 5, to provide a pretreated feed stream 15.

Pyrolysis reaction section 20 can comprise at least one steam cracker or ‘pyrolysis’ furnace configured to crack hydrocarbons in the presence of steam to produce a cracked gas stream and a transfer line exchanger (TLE) or other heat transfer device to quench (and optionally harvest heat from) the cracked gas stream to provide a cooled cracked stream 25. Conventionally, the furnaces of a steam cracking plant create a high temperature environment by the combustion of fuels such as methane and hydrogen, which produces carbon dioxide emissions from a conventional steam cracking plant/process. However, in the present embodiments, the furnace is instead an electric impedance furnace in which electric current heats the tubes through which the feed stream flows.

The primary fractionation and compression section 30 can be configured to provide further heat recovery from and quenching of the cooled cracked gas stream 25, remove one or more components (e.g., fuel oil, hydrogen sulfide, carbon dioxide, water, or a combination thereof) from the cracked gas stream 25, and/or compress the cracked gas stream 25, thus providing a compressed cracked gas stream 38.

The product fractionation or separation section 40 can be configured to fractionate the compressed cracked gas stream 38, selectively hydrogenate one or more streams produced during the fractionation, and provide one or more olefin (e.g., ethylene, propylene) product streams 50. The product fractionation or separation section 40 may also provide one or more byproduct streams 60, such as, without limitation, a C₁ stream, a C₂ saturate stream, a C₃ saturate stream, a C₄ saturate stream, an acetylene stream, a butadiene stream, a 1-butene stream, an isobutylene stream, an aromatics stream, a hydrogen stream, a pyrolysis gasoline stream, and/or a fuel oil stream, or streams comprising a combination of these components. Some of these streams may be recycled to one or more sections of the steam cracking plant. For example, without limitation, the C₂, C₃, and/or C₄ saturates streams may be recycled to one or more of the pyrolysis furnaces of the pyrolysis reaction section 20, hydrogen may be purified (e.g., via a pressure swing adsorption unit (PSA) and a methanation reactor to remove CO) and recycled to a hydrogenation reactor (e.g., a C₂, C₃, acetylene, or di-olefin hydrogenator) and/or utilized as a fuel source (e.g., via fuel cell). The C₁ stream may also be recycled for use as a fuel (e.g., for the production of hydrogen therefrom).

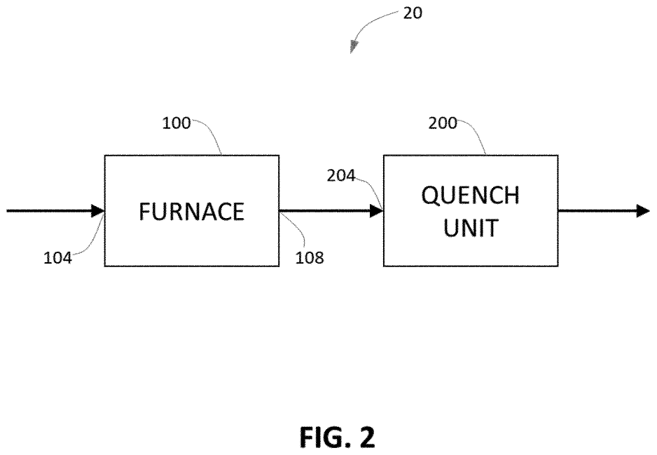

Referring now to FIG. 2, and as also noted above, pyrolysis reaction section 20 can comprise at least one steam cracker or ‘pyrolysis’ furnace 100 configured to crack hydrocarbons in the presence of steam to produce a cracked gas stream, and a quench unit 200 (e.g., a transfer line exchanger (TLE) or other heat transfer device) to quench (and optionally harvest heat from) the cracked gas stream to provide a cooled cracked stream 25. As shown in FIG. 2, the furnace generally includes a fluid inlet 104 and a fluid outlet 108, with the fluid outlet 108 in fluid communication with a fluid inlet 204 of the quench unit 200.

FIGS. 1 and 2 depict one example of a steam cracking system for illustration purposes, but the present pipe isolation joints (PIJs) and electric impedance furnaces can be used in industrial-scale impedance furnaces for any of various industrial processes, such as, for example, steam cracking systems and processes, equipment and processes for reforming to produce syngas for methanol and/or ammonia, heaters and processes for dehydrogenation, and various other applications.

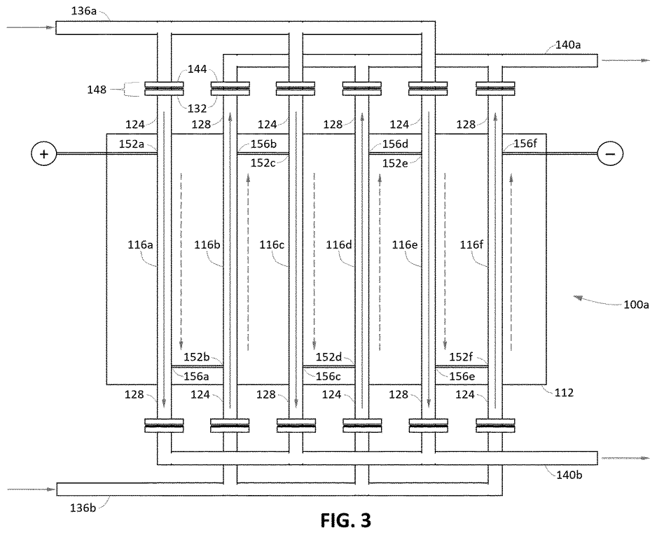

Referring now to FIG. 3, shown there is a conceptual diagram of a first example 100a of an impedance furnace for use in the pyrolysis reaction section of FIG. 2. In this configuration, furnace 100a comprises a housing 112 and a plurality of furnace tubes 116 extending across the housing. Each tube 116 includes a sidewall 120 defining a flow channel extending from an inlet end 124 to an outlet end 128, each of which including a flange 132.

In the depicted configuration, furnace 100a is coupled to first and second inlet manifolds 136a, 136b, and first and second outlet manifolds 140a, 140b. Specifically, inlet ends 124 of the tubes (116) are each coupled to a respective one of inlet manifolds 136a, 136b, and outlet ends 128 of the tubes (116) are each coupled to a respective one of outlet manifolds 140a, 140b. Each inlet manifold 136a, 136b includes a plurality of connections with flanges 144 coupled to respective flanges 132 via pipe isolation joints 148 at inlet ends 124 of tubes 116, and each outlet manifold 140a, 140b includes a plurality of connections with flanges 144 coupled to respective flanges 132 via pipe isolation joints 148 at outlet ends 128 of tubes 116. As described in more detail below, pipe isolation joints 148 electrically insulate the furnace tubes 116 from the manifolds (136a, 136b, 140a, 140b) and therefore prevent electric current from flowing between the tubes and the manifolds.

Because furnace tubes 116 are electrically isolated from the manifolds (136a, 136b, 140a, 140b), an electric potential can be applied across multiple furnace tubes in series. For example, in the depicted configuration-which includes a relatively small number of tubes 116 for illustration purposes-the tubes are electrically connected in series to a voltage difference applied across all of the tubes in series so that a voltage difference applied across the tubes causes current to flow sequentially through each of the tubes. Specifically, a point 156a near outlet end 128 of a first tube 116a is electrically connected to a point 152b nearer inlet end 124 of a second tube 116b, a point 156b nearer outlet end 128 of second tube 116b is electrically connected to a point 152c nearer inlet end 124 of a third tube 116c, a point 156c nearer outlet end 128 of third tube 116c is electrically connected to a point 152d nearer inlet end of a fourth tube 116d, a point 156d nearer outlet end 128 of fourth tube 116d is electrically connected to a point 152e nearer inlet end 124 of fifth tube 116e, and a point 156e nearer outlet end 128 of fifth tube 116e is electrically connected to a point 152f nearer inlet end 124 of a sixth tube 116f. As such, when a voltage difference is applied across the furnace tubes (116) with the high potential (represented by the +circle) at point 152a nearer inlet end 124 of that first tube 116a, and the low potential (represented by −circle) at point 156f nearer outlet end 128 of sixth tube 116f, then current flows sequentially through point 152a, point 156a, point 152b, point 156b, point 152c, point 156c point 152d, point 156d, point 152e, point 156e, point 152f, and point 156f, as indicated by the dashed arrows next to the tubes (116). While a small number of furnace tubes 116 is shown for illustration purposes, industrial furnaces will typically include a greater number of tubes through which fluids can flow and be heated, such that the voltage drop along each tube will typically be on the order of 50 V. For example, a furnace with a voltage drop across all tubes 116 of 4160 V and eighty (80) furnace tubes 116 will exhibit an average voltage drop of roughly 50 V per tube. Thus, the electrical isolation of tubes 116 from the upstream and downstream piping or manifolds (e.g., 136a, 136b, 140a, 140b) and resulting ability to connect tubes in sequence allows a much greater voltage drop overall, dramatically reducing the current required to generate heating duties sufficient for industrial applications. For example, a 20 MW impedance heater with a voltage of 4160 V requires only 4800 amps (versus 1 million amps for a similar heater with a voltage of only 20 V).

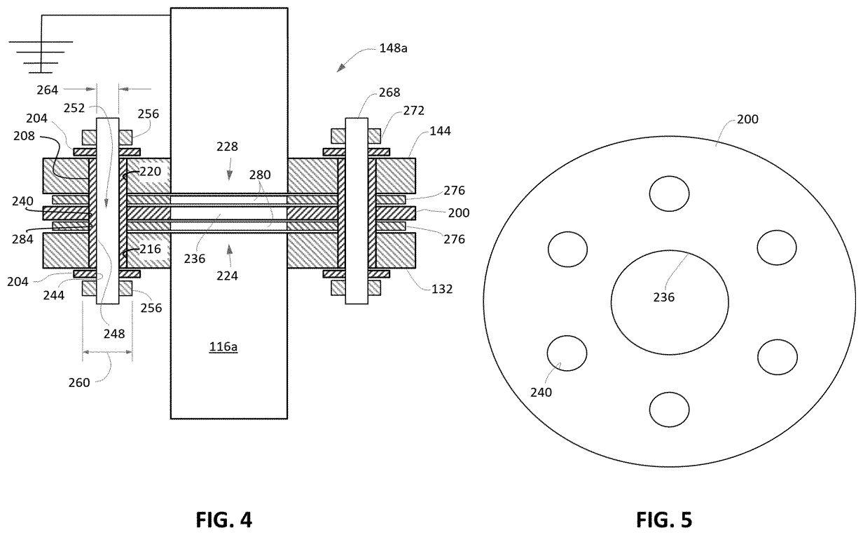

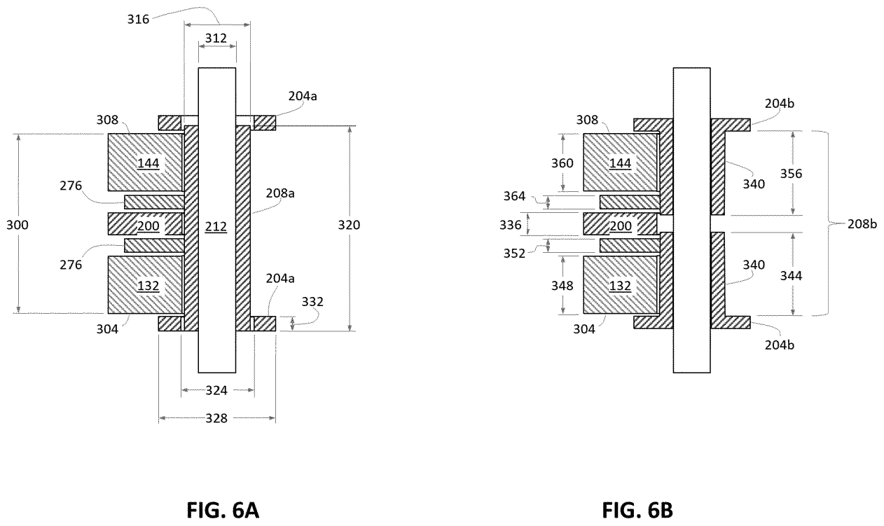

Referring now to FIGS. 4 and 5, FIG. 4 depicts a cross-sectional side view of a first example 148a of the present pipe isolation joints for use in impedance furnaces such furnace 100a, and FIG. 5 depicts a plan view of an insulating disc for use with pipe isolation joint 148a. In the depicted configuration, pipe isolation joint 148a is an assembly that comprises an electrically conductive first flange 132, an electrically conductive second flange 144, an insulating disc 200, a plurality of fastener insulators 204, one or more insulating sleeves 208, and one or more fastener assemblies 212.

Flange 132 defines a first opening 216, and flange 144 defines a second opening 220 that is configured to be aligned with first opening 216 as shown. In the depicted configuration, flange 132 defines a plurality of first openings 216 surrounding a primary first passage 224 (similar to the insulating disc of FIG. 5), and second flange 144 defines a plurality of second openings 220 surrounding a primary second passage 228 such that passage 228 is configured to align with passage 224, and each of second openings 220 is configured to align with a corresponding one of first openings 216.

Insulating disc 200 comprises an electrically non-conductive material and defines one or more disc openings 240. For example, in the depicted example, insulating disc 200 defines a primary disc passage 236 and a plurality of disc openings 240 surrounding and spaced from one another (e.g., at equiangular intervals) primary disc passage 236, such that primary disc passage 236 is configured to align with primary first and second passages 224, 228, and disc openings 240 are configured to align with respective ones of first and second openings 216, 220. Primary disc passage 236, as well as primary first passage 224 and primary second passage 228 (and their respective tubes or pipes), can have an inner diameter of from 1 inch to 10 inches (e.g., between any two of 1 inch, 2 inches, 3 inches, 4 inches, 5 inches, 6 inches, 7 inches, 8 inches, 9 inches, and/or 10 inches). For example, such inner diameter is between 1 inches and 3 inches in some configurations, and between 5 inches and 7 inches in other configurations.

Each fastener insulator 204 comprises an electrically non-conductive material and defines one or more fastener holes 244. For example, in the depicted configuration, each fastener insulator 204 has a conventional washer shape defining a single fastener hole 244; however, in other configurations, each fastener insulator 204 can be shaped as a disc defining a plurality of fastener holes similar to the insulating disc of FIG. 5.

Each insulating sleeve 208 comprises an electrically non-conductive material and defines an inner fastener channel 248. Additionally, and as shown in FIG. 4, each insulating sleeve 208 has an outer profile that is configured to extend through a first opening 216 of flange 132 and a corresponding second opening 220 of flange 144, and into (e.g., and through) disc opening 240 of insulating disc 200.

Each fastener assembly 212 includes a longitudinal medial portion 252, and first and second retention portions 256 each having a transverse dimension 260 that is larger than a corresponding transverse dimension 264 of the medial portion. In at least some configurations, fastener assemblies 212 each comprise electrically conductive material such as steel or another metallic alloy. In the depicted configuration, each fastener assembly comprises a threaded stud 268 with nuts 272 threaded onto opposing ends of the stud, as shown. In other configurations, each fastener assembly can have any configuration that permits the described functionality. For example, in other configurations, each fastener assembly can include a bolt with an enlarged head on one end, and a nut 272 threaded onto the opposing end.

As shown in FIG. 4, flange 132 is configured to be coupled to flange 144 with insulating disc 200 between the flanges. In use, each insulating sleeve 208 extends through a first opening 216 of flange 132, through a corresponding second opening 120 of flange 144, and into (e.g., through) a corresponding disc opening 240. A respective fastener assembly 212 also extends through the insulating sleeve (208) with one of the fastener insulators (204) disposed between the first retention portion 256 and flange 132, and another one of the fastener insulators (204) disposed between the second retention 256 portion and flange 148.

As shown, insulating disc 200, insulating sleeve(s) 208, and fastener insulators 204 are configured such that, once assembled, they prevent the fastener assembly from contacting either flange and prevent flanges 132, 144 from contacting each other, and thereby electrically isolate flange 132 from flange 144.

The electrically nonconductive material of each of insulating disc 200, insulating sleeve(s) 208, and fastener insulator(s) 204 is selected to remain solid and electrically nonconductive at the desired operating temperatures and voltages, for example, at voltages up to 200 V and temperatures up to 300° C. In some configurations, the electrically nonconductive material of insulating disc 200, insulating sleeve(s) 208, and/or fastener insulator(s) is selected to remain solid and electrically nonconductive at voltages above 100V (e.g., above any one of or between any two of: 100 V, 200 V, 300 V, 400 V, 500 V, 600 V, 700 V, 800 V, 900 V, and/or 1000 V) and temperatures in excess of 300° C. (e.g., above any one of or between any two of: 300° C., 400° C., 500° C., 600° C., 700° C., 800° C., 900° C., and/or 1000° C.). For example, in some such configurations, the electrically nonconductive material(s) of each of the insulating disc, insulating sleeve(s), and fastener insulator(s) will remain solid and electrically nonconductive at temperatures up to at least 600° C. and voltages up to at least 500 Volts.

Various polymers (e.g., polyetherimide (PEI), copolymers (e.g., of PEI), and ceramics (e.g., Alumina, Zirconia, Silicon Nitride, Tricalcium Phoshate, and silica-based materials) can be configured to exhibit these characteristics, and are sufficiently shapeable (e.g., via molding, machining, and/or other methods) to be provided with the at least some of the shapes described in this disclosure for the insulating disc, insulating sleeves, and fastener insulators. For example, in certain implementations, a high-purity alumina (>98%) is used.

Some such electrically nonconductive materials, such as polymers, may exhibit physical changes, such as melting, with increasing temperature on the order of 300° C. to 400° C. Some PEIs, for example, exhibit melting temperatures as high as 340° C. to 360° C. As such, as long as it is chemically stable in the present of fluids to which it will be exposed, PEI can be a suitable electrically nonconductive material for desired operating temperatures on the order of 250° C. or 275° C. For some electrically nonconductive materials, the breakdown voltage-voltage potential at which a material begins to permit the flow of current-may eventually decrease with increasing temperature. For example, some dielectric materials may exhibit a breakdown voltage in excess of 5000 V at temperatures up to 900° C. but exhibit decreasing breakdown voltages as temperature increases above 900° C. Examples of electrically nonconductive materials that are be suitable for higher temperature applications include certain ceramics such as Alumina (e.g., high-purity alumina (>98%)).

In the depicted configuration, isolation disc 200, fastener insulators 204, and insulation sleeves 208 comprise a ceramic such as Alumina (e.g., high-purity alumina (>98%)). Such ceramics are typically quite rigid and do not deform under the pressure of the fastener assemblies (212) being tightened. As such, the depicted embodiment of pipe isolation joint 148 also comprises two gaskets 276 disposed on opposing sides of isolation disc 200, with each gasket 276 defining a primary gasket passage 280 and a plurality of gasket openings 284 spaced from one another (e.g., at equiangular intervals) around passage 280. In this configuration, gasket 276 is configured such that gasket openings 284 can, in use, align with respective first openings 216, second openings 220, and disc openings 240, such that each fastener assembly 212 extends through a first opening 216 of flange 132, a corresponding gasket opening 284 of a first gasket 276, a corresponding disc opening 240, a corresponding gasket opening 284 of a second gasket, and a corresponding second opening of flange 144. Thus, when fastener assemblies 212 are tightened, gaskets 276 are compressed between respective sides of isolation disc 240 and a respective one of flange 132 or flange 144 to provide a sealed flow passage between flange 132 and flange 144 to prevent fluid from leaking out of primary first passage 224, disc passage 236, and primary second passage 228 between the insulating disc and the flanges.

For voltages on the order of 100 V and greater (e.g., 1000 V) across the pipe isolation joint, the minimum thickness of the nonconductive material of the isolation disc (200), the fastener insulators (204), and the insulating sleeve(s) 208—for example, the vertical thickness of each of the isolation disc (200) and the fastener insulators (204), and the horizontal thickness of the sidewall of the insulating sleeve-can be 0.15 inches or larger (e.g., larger than any one of or between any two of: 0.15 inches, 0.20 inches, 0.25 inches, 0.30 inches, 0.35 inches, 0.40 inches, 0.45 inches, 0.50 inches, or larger). In some configurations, the thickness of the isolation disc is greater than the thickness of each the fastener insulators (204) and/or greater than the thickness of the sidewall of the insulating sleeve (208). For example, in some configurations, the fastener insulators (204) and insulating sleeve (208) each have a first minimum thickness (e.g., larger than any one of or between any two of: 0.15 inches, 0.20 inches, 0.25 inches, 0.30 inches, 0.35 inches, 0.40 inches, 0.45 inches, 0.50 inches, or larger); and the isolation disc (200) has a second minimum thickness (e.g., larger than any one of or between any two of: 0.20 inches, 0.25 inches, 0.30 inches, 0.35 inches, 0.40 inches, 0.45 inches, 0.50 inches, or larger) that is larger than the first minimum thickness. By way of specific example, in one such configuration, the first minimum thickness is 0.25 inches, and the second minimum thickness is 0.5 inches. In addition to directly prevent contact between electrically conductive surfaces, the configuration of the isolation disc (200) and insulating sleeve (208) also ensure spacing between electrically conductive surfaces and the isolation disc (200) and insulating sleeve (208) can be configured to ensure sufficient minimum spacing-an air gap-to avoid electrical arcing between portions of electrically conductive surfaces that are not directly separated or interposed by a portion of either the isolation disc (200) or insulating sleeve (208).

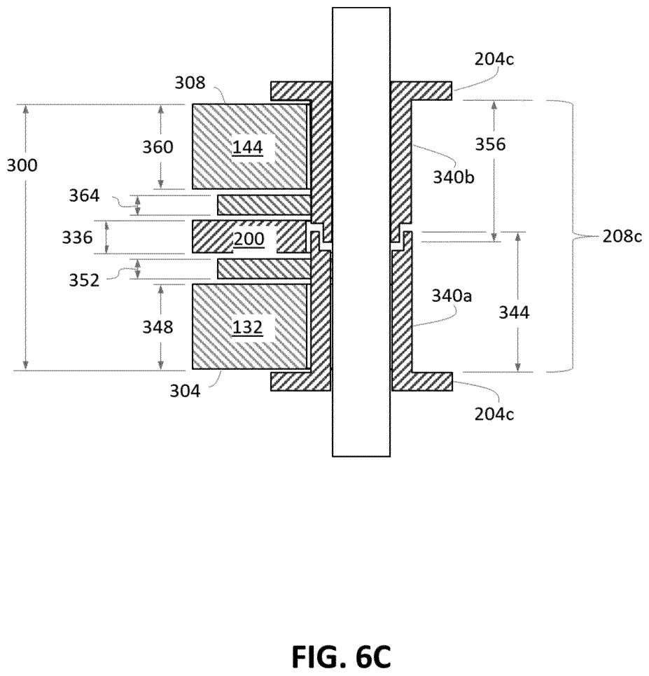

Referring now to FIGS. 6A, 6B, and 6C, shown are partially cutaway, cross-sectional views of different configurations of fastener insulators and insulating sleeves configured for use with the pipe isolation joint of FIG. 4. In each of these views, for illustration purposes, nuts 272 are omitted from fastener assembly 212; and the flanges (132, 144), isolation disc 200, and gaskets 276 are cut away and shown on only the left side of the insulating sleeves. To facilitate description and understanding, the components in these views are shown with some separation and without the nuts of the fastener assembly (212); however, it should be appreciated that when the fastener assembly is tightened or “torqued” to seal the interface between the flanges, the gaskets (276) will be compressed slightly between the isolation disc (200) and the respective flanges (132, 144), resulting in a minimum sealed thickness (MSD) 300 between opposing outer surfaces 304, 308 of the two flanges. Similarly, in configurations that do not include separate gaskets (in addition to the isolation disc), the isolation disc itself may compress slightly or may not be compressible (e.g., if sealing is not required or if tolerances or operating pressures are low enough that seal compression is not required) such that MSD 300 is not influenced by the omitted gaskets (276). As will appreciated by those of ordinary skill in the art, for different configurations or implementations of the present pipe isolation joints, MSD 300 will vary-such as for different applications (e.g., operating pressures), gasket materials, and particular dimensions of flanges, isolation discs, and gaskets-but the determination of MSD 300 for a particular set of circumstances is within the capabilities of a person of ordinary skill in the art.

As will be appreciated by those of ordinary skill in the art, for configurations that include gaskets, MSD 300 typically will not represent the smallest dimension to which the gaskets can be compressed, but will instead represent a degree of compression of the gasket(s) at which a seal is reliably achieved given manufacturing tolerances.

As described in more detail below, MSD 300 can be an important reference point for configuring fastener insulators 204 and insulating sleeves 208. For example, it is generally desirable for the fastener insulators and insulating sleeve(s) to prevent contact between any electrically conductive material surfaces, for example of the flanges and the fastener assemblies. Additionally, it is important that the fastener insulators and insulating sleeve(s) do not physically prevent or impede the fastener assemblies from tightening sufficiently to secure a joint (e.g., and compress the gaskets sufficiently to seal the joint). Finally, at least for certain, more-rigid or brittle materials like ceramics that can be used in the fastener insulators and insulating sleeves, it is important that the fastener insulators and insulating sleeve(s) themselves not be subjected to forces during tightening that would crack or otherwise harm the structural integrity of the fastener insulators and insulating sleeve(s). For example, in the configuration of FIG. 3 with a single insulating sleeve extending between two flat washer-shaped fastener insulators, where the inner opening of the fastener insulators is smaller than the diameter of the insulating sleeve, the length of the fastener sleeve will generally be equal to or slightly less than MSD 300. In this particular example, tolerances are very small to achieve the required seal and avoid compressing the insulating sleeve between the fastener insulators, which can be expected to increase costs.

Even where insulating sleeve 208 does not extend all the way into contact with both fastener insulators 204, electrical conductivity is still prevented when the configuration of the insulating sleeve (208) is such that an air gap of sufficient dimension is provided between portions of electrically conductive surfaces conductive surfaces that are not directly separated or interposed by a portion of either the isolation disc (200) or insulating sleeve (208).

While certain shapes are shown in the depicted example of FIGS. 4 and 5, the present isolation joints can take any of various forms. For example, a gasket for use with the isolating disc and flanges of FIGS. 4 and 5 may take an annular, washer-like shape with an outer diameter that sits entirely within openings 240. Alternatively, the gasket or seal material may comprise one or more pieces and/or one or more layers, or may be applied in a liquid or gel form that sets, hardens, or solidifies once placed in contact with a flange and/or the isolating disc. By way of further example the inner faces of flanges 132, 144 may be conical (e.g., e.g., inward or outward relative to a longitudinal axis of the tubes), may include one or more ridges and/or valleys (e.g., to index or align the flanges relative to one another), and/or may take any other suitable mating shape for a given application.

FIG. 6A shows a further example of a configuration of fastener insulators 204a and an insulating sleeve 208a for use with the pipe isolation joint of FIG. 4. This configuration comprises a single insulating sleeve 208a and two fastener insulators 204a. As shown, insulating sleeve 208a has an inner diameter 312, an outer diameter 316, and a length 320 in the longitudinal direction of the insulating sleeve. As also shown, each fastener insulator 204a is shaped as a flat washer with an inner diameter 324, an outer diameter 328, and a thickness 332. Similar to conventional washers, outer diameter 328 (which may be an outer transverse dimension other than a diameter for non-circular shapes) is larger than the diameter (or other inner transverse dimension) of first and second openings 216, 220). In this configuration, inner diameter 324 of each fastener insulator 204a is larger than outer diameter 316 of insulating sleeve 208a to permit the ends of insulating sleeve 208a to extend into the opening defined by each fastener insulator 204a. Additionally, length 320 of insulating sleeve 208a is greater than the sum of MSD 300 and thickness 332 of one fastener insulator 204a, but smaller than the sum of MSD 300 and the thicknesses (332) of two fastener insulators 204a. With this length, when the fastener assembly is tightened or torqued to achieve MSD 300 between outer surfaces 304, 308 of the flanges, insulating sleeve 208a will extend beyond or overlap the inner surfaces of fastener insulators 204a to prevent contact between electrically conductive components, but also will not be compressed longitudinally between the nuts (or bolt head and nuts) of the fastener assembly.

FIG. 6B shows a further example of a configuration of fastener insulators 204b and an insulating sleeve 208b for use with the pipe isolation joint of FIG. 4. As shown, isolation disc 200 has a thickness 336. In this configuration, insulating sleeve 208b comprises two sub-sleeves 340, and each sub-sleeve 340 is unitary with one of the fastener insulators 204b in what may be referred to as a sleeve washer configuration. In this configuration, length 344 of a first (lower, in the depicted orientation) sub-sleeve 340 is greater than the sum of thickness 348 of flange 132 and thickness 352 of a first (lower) gasket 276 in the minimum sealed dimension (MSD) configuration of the pipe isolation joint. Similarly, in this configuration, length 356 of a second (upper, in the depicted orientation) sub-sleeve 340 is greater than the sum of the thickness 360 of flange 144 and thickness 364 of the second (upper) gasket 276 in the MSD configuration of the pipe isolation joint. Additionally, in this configuration, the sum of length 344 and length 356 is smaller than MSD 300, but larger than the remainder of MSD 300 minus thickness 336 of isolation disc 200. With these lengths of sub-sleeves 340, when the fastener assembly is tightened or torqued to achieve MSD 300 between outer surfaces 304, 308 of the flanges, each sub-sleeve 340 will extend beyond or overlap the respective upper or lower surface of isolation disc 200 to prevent contact between electrically conductive components, but also will not be compressed longitudinally between the nuts (or bolt head and nuts) of the fastener assembly.

FIG. 6C shows a further example of a configuration of fastener insulators 204c and an insulating sleeve 208c for use with the pipe isolation joint of FIG. 4. As shown, isolation disc 200 has a thickness 336. In this configuration, insulating sleeve 208b comprises two sub-sleeves 340, and each sub-sleeve 340 is unitary with one of the fastener insulators 204b in what may be referred to as a sleeve washer configuration. In this configuration, length 344 of a first (lower, in the depicted orientation) sub-sleeve 340a is greater than the sum of thickness 348 of flange 132 and thickness 352 of a first (lower) gasket 276 in the minimum sealed dimension (MSD) configuration of the pipe isolation joint. Similarly, in this configuration, length 356 of a second (upper, in the depicted orientation) sub-sleeve 340b is greater than the sum of the thickness 360 of flange 144 and thickness 364 of the second (upper) gasket 276 in the MSD configuration of the pipe isolation joint. Additionally, in this configuration, the sum of length 344 and length 356 is larger than MSD 300 such that inner ends of sub-sleeves 340a and 340b overlap when the PIJ is assembled. Specifically, in this configuration, first sub-sleeve 340a includes a recess extending proximally (downward in the depicted orientation) from the distal end to define an internal shoulder, and second sub-sleeve 340b includes a narrowed portion extending proximally (upward in the depicted orientation) to define an external shoulder. With these respective end configurations and the lengths of sub-sleeves 340a, 340b, when the fastener assembly is tightened or torqued to achieve MSD 300 between outer surfaces 304, 308 of the flanges, the narrowed portion of second sub-sleeve 340b extends into the recess of first sub-sleeve 340awithout the distal end of either sub-sleeve contacting the respective shoulder of the other sub-sleeve-to prevent contact between electrically conductive components, but also will not be compressed longitudinally between the nuts (or bolt head and nuts) of the fastener assembly.

While sub-sleeves 340a, 340b longitudinally overlap one another within isolation disc 200 in the depicted configuration, in other configurations the lengths of the sub-sleeves can differ such that their respective ends overlap at a different longitudinal position, such as within flange 132 or within flange 144.

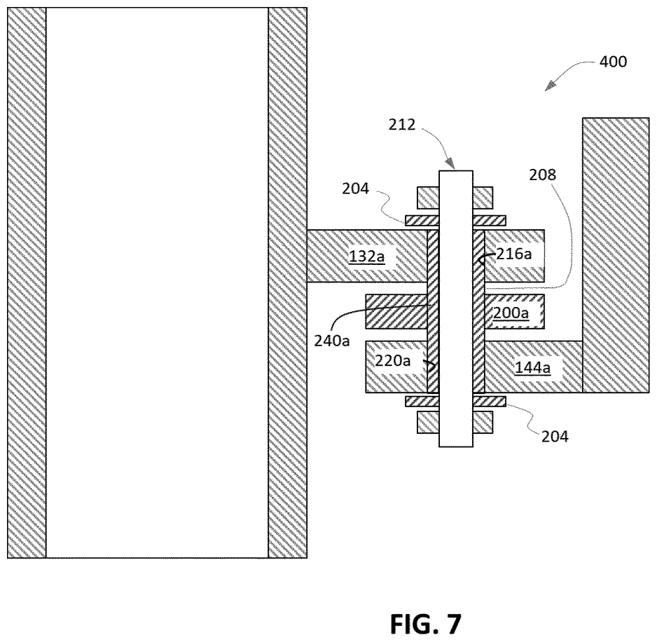

Referring now to FIG. 7, shown is a cross-sectional view of electrically isolating connection 400 for a pipe or tubing hanger. Assembly 400 is similar in structure and function to pipe isolation joint 148a described with reference to FIG. 4, and may utilize the fastener insulators and insulating sleeves described with reference to FIGS. 6A and 6B, with the exception that assembly 400 omits gaskets 276 because its flanges or lugs do not encircle a pipe or tubing for which a seal is necessary within assembly 400 itself. As shown, the assembly comprises an electrically conductive first flange 132a defining a first opening 216a; an electrically conductive second flange 144a defining a second opening 220a; an insulating disc 200a defining a disc opening 240a, a plurality of fastener insulators 204, and an insulating sleeve 208. In this configuration, isolation disc 200a has a substantially rectangular (e.g., square) shape but, in other variations, may have a conventional, circular washer shape with an outer diameter, an inner diameter, and a thickness. As described above, the thickness of isolation disc 200a may vary for different applications and will generally be selected to provide sufficient breakdown voltage for the circumstances of a particular application (e.g., disc material, operating voltage, temperature, and the like). Additionally, while isolation disc 200a is roughly coextensive with an edge of flange 132a and an edge of flange 144a, isolation disc 200a may in other configurations extend beyond all edges of flanges 132a and/or 144a to provide additional protection against arcing and/or conduction of electricity. In the depicted configuration, first flange 132a is coupled to a pipe 404, and second flange 144a is coupled to a support structure such as a wall or ceiling (not shown). In this configuration, the insulating sleeve (e.g., sleeve 208 or a different configuration, as such one similar that of FIG. 6A or FIG. 6B) has a length that is equal to or slightly less than the sum of the thicknesses of flange 132a, isolation disc 200a, and flange 144a, such that fastener assembly 212 can be tightened to secure assembly 400 without cracking or structurally weakening sleeve 208 while still preventing the flow of current between the flanges (132a, 144a) or between either flange and the fastener assembly (212).

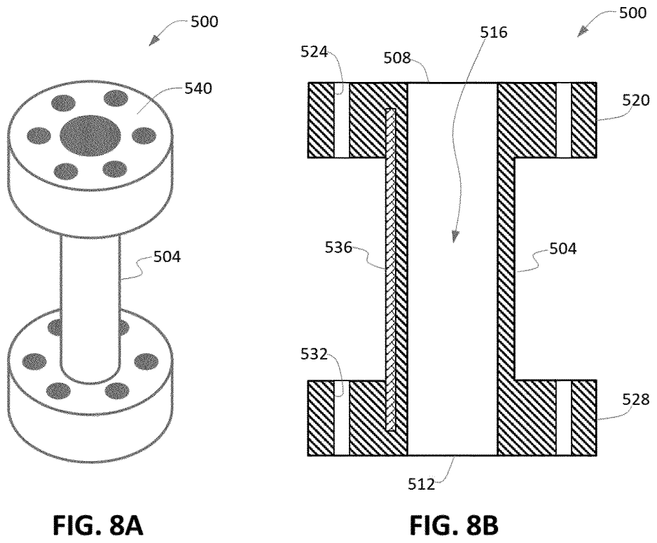

Referring now to FIGS. 8A and 8D, FIG. 8A depicts a perspective view of an electrically isolating pipe joint 500, and FIG. 8B depicts a cross-sectional view of pipe joint 500. In this configuration, pipe joint 500 comprises a tube 504 having a first end 508, a second end 512, and a central passage 516 extending from the first end to the second end. A first flange 520 is coupled to first end 508 of the tube and defines a first passage in fluid communication with central passage 516 of the tube. As shown, first flange 520 also defines a plurality of fastener first openings 524 spaced from one another (e.g., at equiangular intervals) around the first passage. A second flange 528 is coupled to second end 512 of the tube and defines a second passage in fluid communication with central passage 516 of the tube. As shown, second flange 528 defines a plurality of fastener second openings 532 spaced from one another (e.g., at equiangular intervals) around the second passage. In this configuration, tube 504, first flange 520, and second flange 528 each comprise (e.g., are formed of) an electrically non-conductive material that is selected to remain solid and electrically nonconductive at the desired operating temperatures and voltages, for example, at voltages up to 200 V and temperatures up to 300° C. In some configurations, the electrically nonconductive material of tube 504, first flange 520, and second flange 528 is selected to remain solid and electrically nonconductive at voltages above 100V (e.g., above any one of or between any two of: 100 V, 200 V, 300 V, 400 V, 500 V, 600 V, 700 V, 800 V, 900 V, and/or 1000 V) and temperatures in excess of 300° C. (e.g., above any one of or between any two of: 300° C., 400° C., 500° C., 600° C., 700° C., 800° C., 900° C., and/or 1000° C.). For example, in some such configurations, the electrically nonconductive material(s) of each of tube 504, first flange 520, and second flange 528 will remain solid and electrically nonconductive at temperatures up to at least 600° C. and voltages up to at least 500 Volts.

In some configurations, such as the one shown, pipe joint 500 further comprises one or more reinforcing members 536 coupled to and extending along at least a portion of tube 504 to reinforce (increase the overall strength, stiffness, toughness, and/or durability of) the pipe joint. In some such configurations, reinforcing member(s) 536 comprise an electrically conductive material such as a metal alloy and, in such instances, any reinforcing members preferably do not extend to a mating face (e.g., 540) of either of the flanges to avoid electrical communication with a pipe or tube to which pipe joint 500 is coupled. For example, in the furnace of FIG. 3, pipe joint 500 may be used between flanges 132 and 144—even with electrically conductive fasteners and gaskets-to prevent electrical communication between flanges 132 and 144 and their respective furnace tubes 116 or manifolds 136a, 136b, 140a, 140b.

Additional details about various components of steam cracking plants and processes can be found in International Patent Application Publication No. WO2020/150244, which is incorporated by reference in its entirety.

Additional details about various components of syngas synthesis plants and processes can be found in International Patent Application Publication No. WO2020/150247, which is incorporated by reference in its entirety.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure, and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus-or step-plus-function limitations, unless such a limitation is explicitly recited in a given claim using the phrase(s) “means for” or “step for,” respectively.

1. A connection assembly comprising:
an electrically conductive first flange defining a first opening;
an electrically conductive second flange defining a second opening;
an insulating disc defining a disc opening, the insulating disc comprising an electrically non-conductive material that will remain solid and electrically nonconductive at temperatures up to at least 300° C. and voltages up to at least 200 Volts;
a plurality of fastener insulators comprising an electrically non-conductive material, each fastener insulator defining one or more fastener holes;
one or more insulating sleeves comprising an electrically non-conductive material, each defining an inner fastener channel and having an outer profile configured to extend through the first opening and the second opening, and into the disc opening;
one or more fastener assemblies each having a longitudinal medial portion, and first and second retention portions each having a transverse dimension larger than a corresponding transverse dimension of the medial portion;
where the first flange is configured to be coupled to the second flange with the insulating disc between the first and second flanges such that:
the insulating sleeve extends through the first opening and the second opening, and into the disc opening;
the fastener assembly extends through the insulating sleeve with one of the fastener insulators between the first retention portion and the first flange, and another one of the fastener insulators between the second retention portion and the second flange;
the electrically nonconductive material(s) of each of the insulating disc, insulating sleeve(s), and fastener insulator(s) will remain solid and electrically nonconductive at temperatures up to at least 300° C. and voltages up to at least 200 Volts; and
the insulating disc, insulating sleeve(s), and fastener insulators prevent the electrically conductive material of the fastener assembly from contacting either flange and prevent the flanges from contacting each other.

2. The connection assembly of claim 1, where the electrically nonconductive material(s) of each of the insulating disc, insulating sleeve(s), and fastener insulator(s) will remain solid and electrically nonconductive at temperatures up to at least 600° C. and voltages up to at least 500 Volts.

3. The connection assembly of claim 1, where each of the fastener insulators is unitary with a corresponding one of the insulating sleeve(s).

4. The connection assembly of claim 1, where each of the insulating sleeves comprises two sub-sleeves, a first sub-sleeve configured to extend through the first opening and into the disc opening, and a second sub-sleeve configured to extend through the second opening and into the disc opening.

5. The connection assembly of claim 1, where each of the insulating sleeves comprises a single sleeve configured to extend through the first opening, the disc opening, and the second opening.

6. The connection assembly of claim 1, where each of the fastener holes in the plurality of fastener insulators is sized to receive an end of one of the insulating sleeves, and where the first flange is configured to be coupled to the second flange with the insulating disc between the first and second flanges such that a first end of each insulating sleeve extends into the fastener hole of the one of the fastener insulators, and a second end of the insulating sleeve extends into the other of the fastener insulators.

7. The connection assembly of claim 1, where the plurality of fastener insulators comprises a plurality of washers.

8. The connection assembly of claim 1, where the first flange is coupled to a pipe, and the second flange is coupled to a support structure.

9. The connection assembly of claim 1, where:
the first flange defines a primary first passage and a plurality of the first openings spaced from one other around the first passage;
the second flange defines a primary second passage and a plurality of the second openings spaced from one other around the second passage;
the insulating disc defines a primary disc passage and a plurality of the disc openings spaced from one another around the disc passage;
a plurality of the insulating sleeves;
a plurality of the fastener assemblies;
where the first flange is configured to be coupled to the second flange with the insulating disc between the first and second flanges such that:
the first, disc, and second primary passages are aligned;
each of the insulating sleeves extends through one of the first openings and one of the second openings, and into one of the disc openings;
each of the fastener assemblies extends through a corresponding one of the insulating sleeves with one of the fastener insulators between the first retention portion and the first flange, and another one of the fastener insulators between the second retention portion and the second flange; and
the insulating disc, insulating sleeves, and fastener insulators prevent the electrically conductive material of the fastener assemblies from contacting either flange and prevent the flanges from contacting each other.

10. The connection assembly of claim 9, further comprising:
two gaskets each defining a primary gasket passage and a plurality of gasket openings spaced from one other around the gasket passage;
where the first flange is configured to be coupled to the second flange with the insulating disc between the first and second flanges, and the two gaskets disposed between the insulating disc and respective ones of the first and second flanges, such that:
each of the insulating sleeves extends through one of the first openings and one of the second openings, through one of the gasket openings, and into one of the disc openings;
the gaskets are compressed to prevent fluid from leaking out of the first, disc, and second passages between the insulating disc and the flanges.

11. The connection assembly of claim 9, where the first passage, disc passage, and second passage each have an inner diameter of from 1 inch to 10 inches.

12. The connection assembly of claim 1, where the electrically non-conductive material of each of the insulating disc, fastener insulators, and insulating sleeves comprises ceramic, such as high purity alumina (>98%).

13. The connection assembly of claim 1, where each fastener assembly comprises a bolt and a nut.

14. A pipe joint comprising:
a tube having a first end, a second end, and a central passage extending from the first end to the second end;
a first flange coupled to the first end of the tube and defining a first passage in fluid communication with the central passage of the tube, the first flange defining a plurality of fastener first openings spaced from one another around the first passage; and
a second flange coupled to the second end of the tube and defining a second passage in fluid communication with the central passage of the tube, the second flange defining a plurality of fastener second openings spaced from one another around the second passage;
where the tube, first flange, and second flange comprising an electrically non-conductive material that will remain solid and electrically nonconductive at temperatures up to 300° C. and voltages up to at least 200 Volts.

15. The pipe joint of claim 14, further comprising:
electrically conductive reinforcing members coupled to and extending along at least a portion of the tube;
where the reinforcing members to not extend to a mating face of either of the flanges.
